(19) United States
(12) Patent Application Publication
(10) Pub. No.: US 2024/0311840 A1
(43) Pub. Date: Sep. 19, 2024

(54) MANAGING APPEASEMENT REQUESTS USING USER SEGMENTATION

(71) Applicant: Maplebear Inc. (dba Instacart), San Francisco, CA (US)

(72) Inventors: Qing Maio, Marietta, GA (US); Robert Border, Decatur, GA (US)

(21) Appl. No.: 18/184,565

(22) Filed: Mar. 15, 2023

(51) Int. Cl. G06Q 30/016; G06F 18/23213

(52) U.S. Cl. CPC G06Q 30/016; G06F 18/23213; G06Q 10/0837

(57) ABSTRACT

An online concierge system determines whether a user's appeasement request is fraudulent. The online concierge system compares the user's appeasement request rate to the appeasement request rates of similar users in a user segment identified with a user segmentation model. The online concierge system computes an appeasement model that represents the appeasement request rates of the users in the user segment. The online concierge system computes an outlier score for the user based on the appeasement model. The online concierge system compares the outlier score to a threshold. If the outlier score exceeds the threshold, the online concierge system may determine that the appeasement request is not likely fraudulent and thus applies an appeasement action to the user. If the outlier score does not exceed the threshold, the online concierge system may determine that the appeasement request is likely fraudulent and thus applies a security action to the user.

### BACKGROUND

An online concierge system is an online system that allows users to order items from a retailer to be delivered to them. Occasionally, issues may arise as a part of the ordering process. For example, orders may be delivered to the wrong location, items may be missing or damaged, or orders may be delivered outside of a target delivery timeframe. As such, online concierge systems may provide a way for users to make appeasement requests to the online concierge system, such as requests for a return or refund of their orders.

However, while most users may make appeasement requests based on valid issues with their orders, the online concierge system may also receive fraudulent appeasement requests from users seeking to receive an appeasement action without an issue occurring with their order. For example, a malicious user may incorrectly claim an item was missing to receive a refund on the allegedly missing item. An online concierge system may compute an appeasement request rate to identify users who may be submitting fraudulent appeasement requests. For example, an online concierge system may determine whether a user submits more appeasement requests than a typical user, and may identify that user as likely submitting fraudulent appeasement requests. However, the appeasement request rate of a user is not a perfect metric for identifying fraud in these scenarios. For example, a user may have a high number of appeasement requests without committing fraud because their delivery address is difficult to find or access or because they commonly order items to be delivered from a retailer that has a large number of similar items that can be easily confused by a picker. Similarly, a different user with a low number of appeasement requests may be submitting fraudulent appeasement requests by always claiming an item is missing from an order, even when the item was delivered by a picker. Accordingly, it may be important to improve the process of detecting fraudulent activity in such instances.

### SUMMARY

In accordance with one or more aspects of the disclosure, an online concierge system determines whether a user's appeasement request is fraudulent by determining the likelihood that the user would have their appeasement request rate (i.e., how often they request appeasements) through normal, non-fraudulent user activity. To do so, the online concierge system compares the user's appeasement request rate to the appeasement request rates of a set of similar users.

The online concierge system identifies a set of similar users by splitting users into user segments with a user segmentation model (e.g., a clustering model). The user segmentation model uses signals from user data (e.g., location, types of orders, types of ordered items, or other user data) to categorize users into user segments that may be indicative of similar appeasement request rates. In an embodiment, the online concierge system may use unsupervised learning techniques to train a model to classify users into user segments. The online concierge system computes an appeasement model (e.g., a probability mass function) that represents the appeasement request rates of the users in each user segment.

The online concierge system may use the computed appeasement models to determine whether a user is submitting fraudulent appeasement requests. When the online concierge system receives an appeasement request from a user, the online concierge system computes an outlier score for the user based on the appeasement model for the user segment of which the user is a member. An outlier score represents a likelihood that a random user in the user segment would have an appeasement request rate equal to or greater than the user's appeasement request rate. In other words, the outlier score represents the likelihood that the user would have an appeasement request rate that is at least as high as the one they have based on the other users in the user segment. The online concierge system compares the outlier score to a threshold to determine how to respond to the user's appeasement request. If the outlier score exceeds the threshold, the online concierge system may determine that the appeasement request is not likely to be fraudulent and thus applies an appeasement action to the user (e.g., issuing a refund). However, if the outlier score does not exceed the threshold, the online concierge system may determine that the appeasement request is likely to be fraudulent and thus applies a security action to the user. In some embodiments, the online concierge system uses multiple thresholds for the outlier score to select a security action to apply to the user. For example, if the outlier score exceeds a first, lower threshold but does not exceed a second, higher threshold, then the online concierge system may apply a less serious security action to the user than if the outlier score did not exceed the first threshold.

By segmenting users and computing appeasement models for users based on their user segments, the online concierge system is able to better account for the factors involved in users placing orders that may be unrelated to the likelihood that the user is committing fraud and is thus better able to identify fraudulent users. Moreover, by using a probability mass function as the appeasement model instead of a more complex model, the online concierge system may reduce processing power associated with identifying fraudulent users.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 is a flowchart for a method of managing customer appeasement requests, in accordance with one or more embodiments.

FIG. 4 illustrates appeasement models for different user segments, in accordance with one or more embodiments.

FIG. 5 illustrates a user segmentation model, in accordance with one or more embodiments.

### DETAILED DESCRIPTION

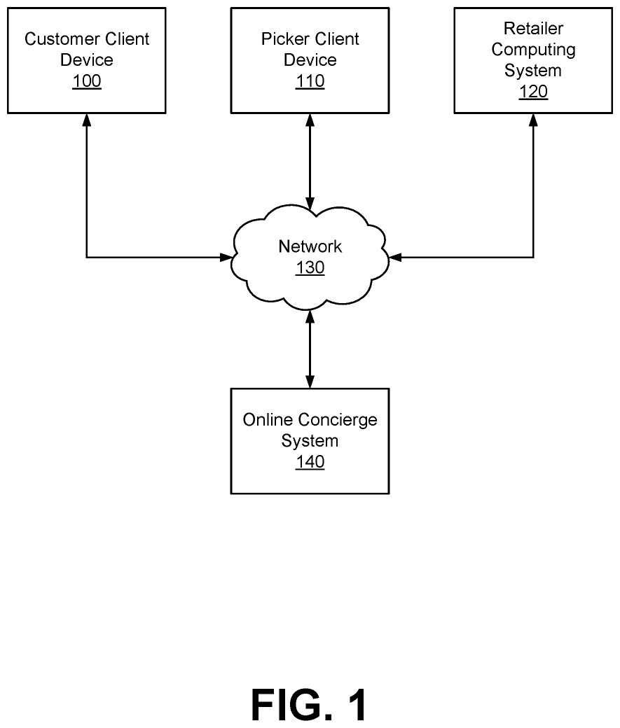

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item”, as used herein, means a good or product that can be provided to the customer through the online concierge system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provides portions of the payment from the customer to the picker and the retailer.

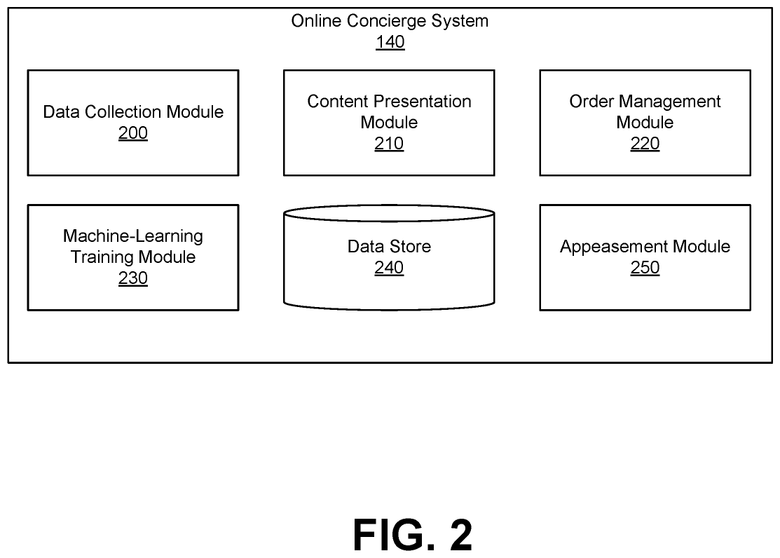

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has services orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer location from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine learning training module 230 trains machine learning models used by the online concierge system 140. The online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online concierge system 140. For example, the data store 240 stores customer data, item data, order data, and picker data for use by the online concierge system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data and may use databases to organize the stored data.

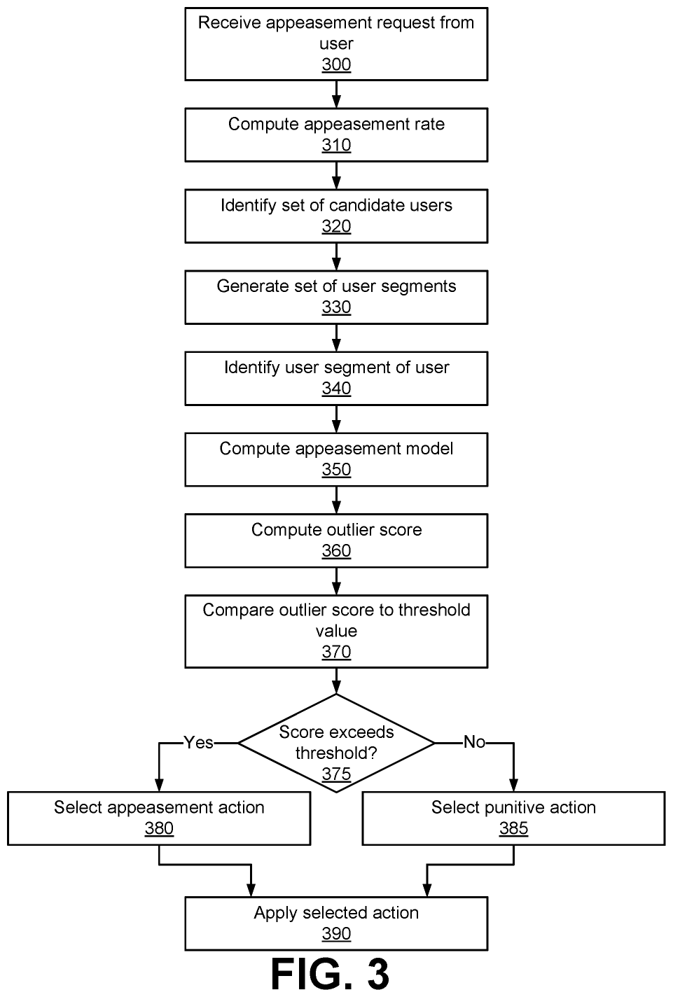

The appeasement module 250 manages appeasement requests received from users and determines an appeasement action or security action to apply to each request. An appeasement action is an action the online concierge system 140 applies to a user to remedy an issue that occurred with the user's order. A security action is an action the online concierge system 140 applies to the user to address possible misuse or fraud of the online concierge system 140 by the user. Further details of the method of managing appeasement requests are discussed in FIG. 3.

FIG. 3 is a flowchart for a method of managing customer appeasement requests, in accordance with some embodiments. Alternative embodiments may include more, fewer, or different steps from those illustrated in FIG. 3, and the steps may be performed in a different order from that illustrated in FIG. 3. These steps may be performed by an online concierge system (e.g., online concierge system 140). Additionally, each of these steps may be performed automatically by the online concierge system without human intervention.

The online concierge system 140 receives 300 an appeasement request from the customer client device corresponding to the customer. An appeasement request is a request from a customer for an appeasement to be applied to the customer's order. For example, if an item is missing from the customer's order, the customer may submit an appeasement request to get a refund for that item. Similarly, the customer may request an appeasement when one or more items in the customer's order is incorrect or damaged. The appeasement request may include order data for an order associated with the appeasement request and customer data describing characteristics of the customer. Additionally, the request may include information added by the customer. For example, the customer may include information that explains which items the appeasement is requested for or why the appeasement is requested.

The online concierge system 140 computes 310 an appeasement request rate for the customer based on a set of prior appeasement requests from the customer and the customer's order history. An appeasement request rate represents the frequency at which the customer makes appeasement requests. The online concierge system 140 may compute the appeasement request rate as a ratio of a number of appeasement requests received from the customer over a number of orders placed by the customer. For example, if the online concierge system 140 has received two appeasement requests from the customer over a total of 20 orders placed by the customer, the online concierge system 140 may compute the appeasement request rate for the user to be 10%. The online concierge system 140 may compute the appeasement request rate for a customer based on orders that the customer has placed within a time window. For example, the online concierge system 140 may compute an appeasement request rate based on orders the customer has placed within a year of the most recent appeasement request or most recent customer order.

The online concierge system 140 accesses user data associated with a set of candidate users. In some embodiments, the online concierge system identifies 320 a particular set of candidate users and accesses the user data associated with that identified set of candidate users. In some embodiments, the online concierge system 140 may identify the set of candidate users based on order data associated with the users. For example, the online concierge system 140 may identify users who have previously ordered from the same retailer associated with the order corresponding to the received appeasement request, users who have previously ordered items similar to those included in the order, users who have ordered within a time window, users who have previously ordered in the same geographic region where the order was placed/picked-up/delivered, or who have placed a similar number of orders. The online concierge system 140 may alternatively identify a random set of candidate users, or a set of candidate users representative of some or all users of the online concierge system.

The online concierge system 140 generates 330 a set of user segments based on the set of candidate users. A user segment is a distinct subset of users within the set of candidate users that may have similar characteristics or ordering habits, which may be indicative of them having similar appeasement request rates. The online concierge system 140 generates the set of user segments by applying a user segmentation model to user data for the set of candidate users. A user segmentation model is a machine-learning model that takes user data as input and outputs a segmentation score. The segmentation score may be an indicator of which segment the user belongs to. For example, the segmentation score may be an indicator generated through k-means clustering or may be an indicator that identifies the user as one of a predefined set of segments, such as segments in a classifier. The user segmentation model may use an unsupervised machine-learning technique to segment the set of candidate users. For example, the user segmentation model may apply a clustering algorithm, such as a k-means clustering algorithm, to user data corresponding to the set of candidate users.

In some embodiments, the online concierge system 140 may generate a set of user segments by applying a user segmentation model that considers user data or order data that describe signals that are typically correlated with real errors in orders. Such signals may include the rate at which an item in the order is typically found by a picker, the replacement rate for an item in the order, the percentage of non-grocery items in the order, the number of retail locations the items in the order came from, or the number of other orders simultaneously fulfilled by a picker who is fulfilling the order. In some embodiments, the online concierge system 140 determines a number of user segments to generate and use the user segmentation model to generate the number of user segments.

In some embodiments, the online concierge system 140 may compute user segments using heuristics. For example, the online concierge system 140 may compute user segments based on geographic region using information like the zip code the user requested delivery of an order to.

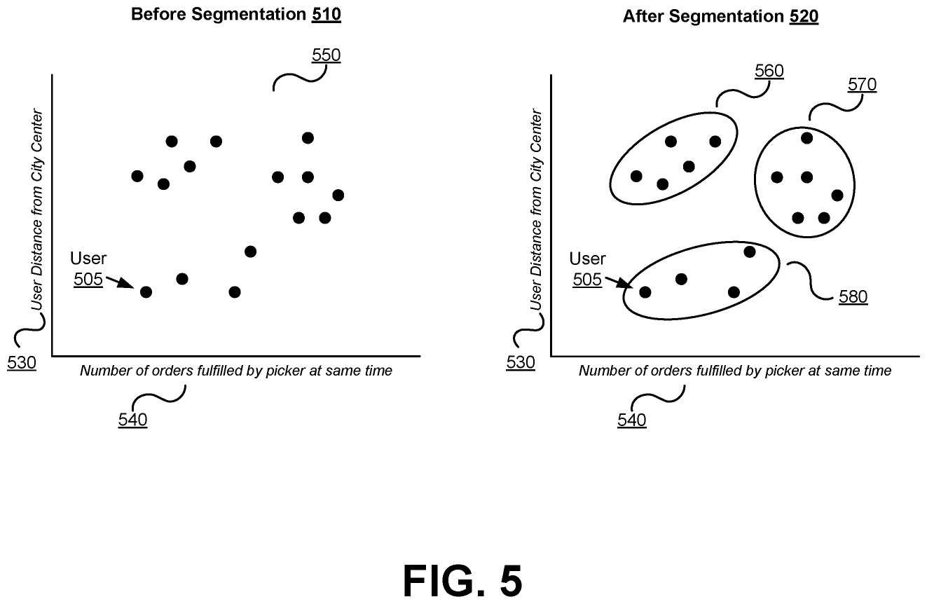

The online concierge system 140 may pre-compute user segments or compute user segments in response to receiving an appeasement request from a user. Further details of a user segmentation model are described with respect to FIG. 5.

The online concierge system 140 identifies 340 the user segment of which the user is a member. If the identified user segment has too few users, the online concierge system 140 may re-apply the user segmentation model to generate segments with less granularity. For example, say the online concierge system 140 generated segments where users in each segment had the same zip code. In this example, users in small rural towns may not have many other users in their segment to be compared to, and as such, the online concierge system 140 may re-apply the user segmentation model such that those users get placed in a segment based on a larger geographic region, such as a county.

The online concierge system computes 350 an appeasement model for the user segment. The appeasement model represents the appeasement request rates of users for the users in the identified segment. For example, the appeasement model may include a probability mass function, a function that gives the probability that a random variable is equal to a value based on a probability distribution. In this case, the probability mass function may give the probability that any one user's appeasement request rate is equal to the appeasement request rate of other users in the user segment. Using the appeasement model, the online concierge system 140 can compare a particular user's appeasement request rate to the appeasement request rates of other users in the segment. The online concierge system 140 may pre-compute appeasement models for each segment or may compute the appeasement model in response to receiving an appeasement request from a user.

The online concierge system 140 may compute the probability mass function by using the equation for a binomial probability mass function:

$$P ( k , n , p ) = Pr Pr ( k ; n , p ) = Pr ( X = k ) = ( \frac{n}{k} ) {{p}^{k} ( 1 - p )}^{n - k}$$

$$for k = 0 , 1 , 2 , … , n , where$$

$$( \frac{n}{k} ) = \frac{n !}{k ! ( n - k ) !}$$

is the binomial coefficient.

By using the above equation, the online concierge system 140 may compute the probability P of receiving k appeasement requests from a user, in a total of n orders, given that the average appeasement request rate within the user segment is p.

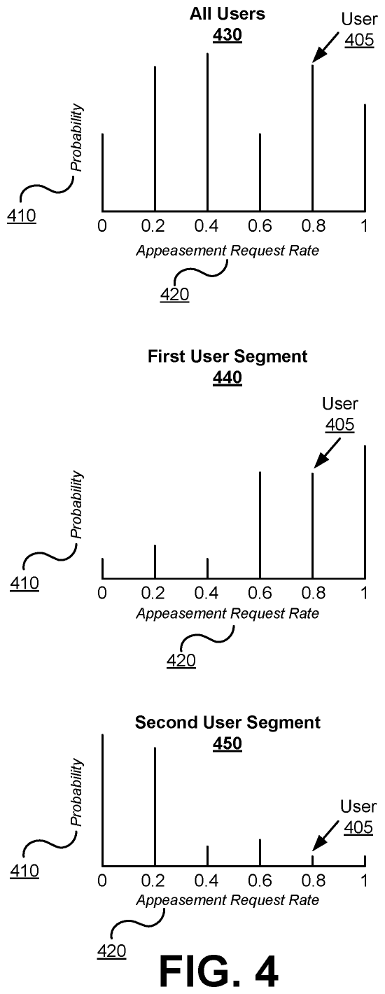

The online concierge system 140 may compute the appeasement model by summing a set of probability mass functions. That way, the online concierge system 140 may model the probability of a user having not just exactly k appeasement requests, but k or more appeasement requests in a total of n orders. For example, if C(3, 5, 5.8%) represents the probability of a customer who had three or more appeasement requests in a total of five orders where 5.8% is the average appeasement request rate for the user segment, the online concierge system 140 may compute the appeasement model such that C(3, 5, 5.8%) is the sum of the probability of a user having three appeasement requests in a total of five orders, P(3, 5, 5.8%), the probability of a user having four appeasement requests in a total of five orders, P(4, 5, 5.8%), and the probability of a user having five appeasement requests in a total of five orders P(5, 5, 5.8%). Further details of an appeasement model are described with respect to FIG. 4.

The online concierge system 140 computes 360 an outlier score for the user based on the appeasement model. An outlier score is a likelihood that a random user in the identified user segment would have the appeasement request rate associated with the user. The outlier score can thereby represent a likelihood that the user is an outlier among the users in the identified user segment. For the example where the online concierge system 140 computes the outlier score for the user as the probability of the user having k or more appeasement requests in a total of n orders, a low outlier score may indicate that the user is more of an outlier within the user segment and thus is more likely to be submitting fraudulent appeasement requests. The low outlier score means that few other users had the same proportion or a higher proportion of appeasement requests with their orders. In some embodiments, the online concierge system 140 computes the outlier score by comparing the appeasement request rate of the user to an average appeasement request rate of users in the identified segment.

The online concierge system 140 compares 370 the outlier score to a threshold value. Responsive to the outlier score meeting or exceeding the threshold 375, the online concierge system 140 selects 380 an appeasement action. The online concierge system 140 may select 380 the appeasement action based on the appeasement request. Depending on the appeasement request, the appeasement action may be redelivering the item/order or refunding some or all of the cost of the item/order.

If the outlier score does not exceed the threshold 375, the online concierge system 140 selects 385 a security action. The security action may be refunding the order, but along with warning the user not to submit appeasement requests that are fraudulent, requesting further information from the user (e.g., further text or images to support the request), requiring the user to meet with a customer service agent, or deactivating the user (e.g., blocking the user from being able to use the customer client device 100 to place an order with the online concierge system 140). The online concierge system 140 may select 385 the security action based on comparing the user's outlier score to a set of thresholds, where the thresholds in the set of thresholds do not exceed the threshold 375. For example, responsive to the outlier score not exceeding the lowest threshold in the set of thresholds, the online concierge system 140 may determine that it is highly likely the appeasement request is fraudulent and select 385 the security action of deactivating the user. In another example, responsive to the outlier score exceeding the highest threshold in the set of thresholds (while still failing to exceed the threshold 375), the online concierge system 140 may determine that the appeasement request is likely to be fraudulent, but not highly likely. In this case, the online concierge system 140 may select 385 the security action of requesting further information from the user.

The online concierge system 140 may adjust the appeasement action on a case-by-case basis. For example, the online concierge system 140 may select and apply the refund with a warning action for the user on their first appeasement request, regardless of how the user's outlier score compares to the thresholds. In another example, the online concierge system 140 may compute a value of orders associated with the user within a time window (e.g., compute revenue minus costs for the time window of one year) and adjust the appeasement action if the user is profitable. In this example, the online concierge system 140 may refund a profitable user regardless of how the user's outlier score compares to the thresholds.

The online concierge system 140 applies 390 the selected action to the user. Applying the action may take on different forms for different actions. In some embodiments, the online concierge system 140 may apply the action by transmitting a message or notification to the user describing the action (e.g., for security actions of requesting further information from the user or requiring the user to meet with a customer service agent). A message or notification may include an email message, text message, push notification, notification within a client application on the customer client device 100, or any other way of communicating with the user. In some embodiments, the online concierge system 140 may apply the action by performing additional steps. For example, for the appeasement action of redelivering an order, the online concierge system 140 may apply the action by performing the additional steps of re-placing the order and managing the order with order management module 220. In some embodiments, the online concierge system 140 may apply the action by performing additional steps and transmitting a message or notification to the user describing the action. For example, for the security action of refunding the user but warning the user not to submit appeasement requests that are fraudulent, the online concierge system 140 may both perform the additional steps of issuing a refund (e.g., using payment information stored in association with the user) and may transmit a message describing the applied action to the user.

FIG. 4 illustrates appeasement models for different user segments, in accordance with some embodiments. Each plot contains an example probability mass function, with probability 410 plotted against appeasement request rate 420. Plot 430 shows an example probability mass function for all users, while plots 440 and 450 show probability mass functions for two different user segments: a first user segment 440 and a second user segment 450. As shown in the plots, the probability of users in the first user segment 440 having a high appeasement request rate is relatively high. The probability of users in the second user segment 450 having a high appeasement request rate is relatively low.

User 405 is shown as having an appeasement request rate of 0.8. If the online concierge system 140 were to compare user 405 to other users in the group of all users 430, the appeasement request rate of user 405 would not look like an outlier. User 405 has a similar probability of having an appeasement request rate of 0.8 as the probability of having an appeasement request rate of 0.2 or 0.4. If the online concierge system 140 were to compare user 405 to users in the first user segment 440, the appeasement request rate of user 405 would similarly not look like an outlier, as user 405 has a similar probability of having an appeasement request rate of 0.6 or 1. However, if the online concierge system 140 were to compare user 405 to users in the second user segment 450, user 405 is an outlier, as shown by the relatively low probability of having an appeasement request rate as high as 0.8. By identifying which user segment a user is a member of, the online concierge system 140 may more accurately determine if the appeasement request rate of the user is an outlier.

FIG. 5 illustrates example user segments, in accordance with some embodiments. FIG. 5 illustrates two plots: a first plot showing a set of users 550 before segmentation 510 and second plot showing three sets of users 560, 570, 580 after segmentation 520. Each plot displays the users plotted as a function of two independent variables: the user distance from a city center 530 and a number of orders fulfilled by a picker at the same time 540. Each plot also contains a particular user, user 505.

The online concierge system 140 generates user segments from the set of users 550 by identifying clusters of users on the plot. In this example, clusters of users have a similar distance from the city center 530 and a similar number of orders fulfilled by a picker at the same time 540. For instance, the set of users 570 all have a high number of orders fulfilled by the picker at the same time 540 and are a medium distance from the city center 530. The set of users 560 have a low number of orders fulfilled by the picker at the same time 540 and are a far distance from the city center 530. The set of users 580 have a wider range of number of orders fulfilled by the picker at the same time 540 but are all a close distance from the city center 530. While this example shows segmenting users based on the two variables shown in the plot, in other embodiments the online concierge system 140 may cluster based on more than two variables.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising, at a computer system comprising a processor and a computer-readable medium:
receiving an appeasement request from a user device corresponding to a user of an online concierge system, wherein the appeasement request identifies an order associated with the user for which the user requests that an appeasement be applied;
computing an appeasement request rate for the user based on a set of prior appeasement requests from the user;
accessing user data for a set of candidate users, wherein the set of candidate users comprises the user;
generating a set of user segments based on the set of candidate users, wherein a user segment comprises a distinct subset of users within the set of candidate users, and wherein generating the set of user segments comprises:
applying a user segmentation model to the user data for the set of candidate users to generate a segmentation score for each candidate user in the set of candidate users, wherein the user segmentation model is a machine-learning model trained to generate a segmentation score for a user based on user data describing that user, and wherein a segmentation score for a user represents the user segment to which the user belongs; and
grouping the set of candidate users into the set of user segments based on the segmentation score for each candidate user;
identifying a user segment of the set of user segments of which the user is a member;
generating an appeasement model based on users in the identified user segment, wherein the appeasement model is a model representing appeasement request rates of users in the identified user segment;
generating an outlier score for the user based on the appeasement model, wherein the outlier score represents a likelihood that a random user within the identified user segment would have the appeasement request rate associated with the user;
comparing the outlier score to a threshold value; and
based on the comparing, applying an appeasement action to the user.

2. The method of claim 1, wherein computing the appeasement request rate comprises computing a ratio of a number of appeasement requests received from the user to a number of orders placed by the user.

3. The method of claim 1, wherein accessing user data for a set of candidate users comprises identifying the set of candidate users based on order data describing characteristics of orders placed by the set of candidate users.

4. The method of claim 3, wherein orders placed by the set of candidate users were placed from a same geographic region as the order identified by the appeasement request.

5. The method of claim 1, wherein the user segmentation model is an unsupervised machine learning model.

6. The method of claim 1, wherein the user segmentation model uses k-means clustering to generate the user segments.

7. The method of claim 1, wherein the appeasement model includes a probability mass function, wherein the probability mass function gives a probability that a random variable is equal to a value based on a probability distribution.

8. The method of claim 1, wherein generating the outlier score comprises comparing the appeasement request rate of the user to an average appeasement request rate of users in the identified segment.

9. The method of claim 1, wherein applying the appeasement action comprises selecting the appeasement action from a set of possible appeasement actions based on the appeasement request, wherein the set of possible appeasement actions includes redelivering the order and issuing a refund to the user.

10. The method of claim 1 further comprising:
responsive to the outlier score not exceeding the threshold value, selecting a security action from a set of possible security actions; and
applying the security action to the user.

11. The method of claim 10, wherein selecting the security action comprises comparing the outlier score to a set of threshold values, wherein the set of threshold values comprises the threshold value.

12. The method of claim 10, wherein selecting the security action comprises selecting the security action based on a value associated with orders placed by the user.

13. A non-transitory computer-readable medium storing instructions that, when executed by a processor, cause the processor to:
receive an appeasement request from a user device corresponding to a user of an online concierge system, wherein the appeasement request identifies an order associated with the user for which the user requests that an appeasement be applied;
compute an appeasement request rate for the user based on a set of prior appeasement requests from the user;
access user data for a set of candidate users, wherein the set of candidate users comprises the user;
generate a set of user segments based on the set of candidate users, wherein a user segment comprises a distinct subset of users within the set of candidate users, and wherein generating the set of user segments comprises:
applying a user segmentation model to the user data for the set of candidate users to generate a segmentation score for each candidate user in the set of candidate users, wherein the user segmentation model is a machine-learning model trained to generate a segmentation score for a user based on user data describing that user, and wherein a segmentation score for a user represents the user segment to which the user belongs; and
grouping the set of candidate users into the set of user segments based on the segmentation score for each candidate user;
identify a user segment of the set of user segments of which the user is a member;
generate an appeasement model based on users in the identified user segment, wherein the appeasement model is a model representing appeasement request rates of users in the identified user segment;
generate an outlier score for the user based on the appeasement model, wherein the outlier score represents a likelihood that a random user within the identified user segment would have the appeasement request rate associated with the user;
compare the outlier score to a threshold value; and
apply an appeasement action to the user based on whether the outlier score exceeds the threshold value.

14. The non-transitory computer-readable medium of claim 13, wherein the instructions for computing the appeasement request rate comprise instructions that cause the processor to compute a ratio of a number of appeasement requests received from the user to a number of orders placed by the user.

15. The non-transitory computer-readable medium of claim 13, wherein the instructions for accessing user data for a set of candidate users comprise instructions that cause the processor to identify the set of candidate users based on order data describing characteristics of orders placed by the set of candidate users.

16. The non-transitory computer-readable medium of claim 15, wherein orders placed by the set of candidate users were placed from a same geographic region as the order identified by the appeasement request.

17. The non-transitory computer-readable medium of claim 13, wherein the user segmentation model is an unsupervised machine learning model.

18. The non-transitory computer-readable medium of claim 13, wherein the user segmentation model uses k-means clustering to generate the user segments.

19. The non-transitory computer-readable medium of claim 13, wherein the appeasement model includes a probability mass function, wherein the probability mass function gives a probability that a random variable is equal to a value based on a probability distribution.

20. A system comprising:
a processor; and
a non-transitory computer-readable medium storing instructions that, when executed by the processor, cause the processor to:
receive an appeasement request from a user device corresponding to a user of an online concierge system, wherein the appeasement request identifies an order associated with the user for which the user requests that an appeasement be applied;
compute an appeasement request rate for the user based on a set of prior appeasement requests from the user;
access user data for a set of candidate users, wherein the set of candidate users comprises the user;
generate a set of user segments based on the set of candidate users, wherein a user segment comprises a distinct subset of users within the set of candidate users, and wherein generating the set of user segments comprises:
applying a user segmentation model to the user data for the set of candidate users to generate a segmentation score for each candidate user in the set of candidate users, wherein the user segmentation model is a machine-learning model trained to generate a segmentation score for a user based on user data describing that user, and wherein a segmentation score for a user represents the user segment to which the user belongs; and
grouping the set of candidate users into the set of user segments based on the segmentation score for each candidate user;
identify a user segment of the set of user segments of which the user is a member;
generate an appeasement model based on users in the identified user segment, wherein the appeasement model is a model representing appeasement request rates of users in the identified user segment;
generate an outlier score for the user based on the appeasement model, wherein the outlier score represents a likelihood that a random user within the identified user segment would have the appeasement request rate associated with the user;
compare the outlier score to a threshold value; and
apply an appeasement action to the user based on whether the outlier score exceeds the threshold value.
